(19) United States
(12) Patent Application Publication
(10) Pub. No.: US 2010/0098899 A1
(43) Pub. Date: Apr. 22, 2010

(54) PROCESS FOR MANUFACTURING PLASTIC MOLDING AND MOLDING MANUFACTURED ACCORDING TO THAT PROCESS

(76) Inventors: Andree Burgstaler, Dielingen (DE); Olaf Beutler, Diepholz (DE)

Correspondence Address: MCGLEW & TUTTLE, PC, P.O. BOX 9227, SCARBOROUGH STATION, SCARBOROUGH, NY, 10510-9227, US

(21) Appl. No.: 11/995,250

(22) PCT Filed: Jun. 27, 2006
(86) PCT No.: PCT/DE06/01105

§ 371 Date: Jan. 10, 2008

(30) Foreign Application Priority Data
Jul. 13, 2005 (DE) 10 2005 033 186.6

(51) Int. Cl. B32B 3/02; B29C 45/00

(52) U.S. Cl. 428/66.1; 264/328.1

(57) ABSTRACT

A process for manufacturing plastic moldings while increasing the coefficient of viscosity of the raw material used to manufacture same and to a molding manufactured according to the process. To increase the loadability and the service life of moldings manufactured by injection molding, which are subject to dynamic loads during their use, the granular material used is tempered before the shaping processing in the injection molding process for a period of 10 hours to 30 hours at a temperature between 90 C and 150 C. Without resorting to higher-priced materials, highly loadable moldings can be manufactured by this process, which can be advantageously used by the manufacturer without a greater effort. A corresponding molding, such as a worm gear, manufactured according to the process from a granular material with an original solution viscosity between 180 mL/g and 190 mL/g, has a solution viscosity between 180 mL/g and 200 mL/g.

### CROSS REFERENCE TO RELATED APPLICATIONS

This application is a United States National Phase application of International Application PCT/DE2006/001105 and claims the benefit of priority under 35 U.S.C. §119 of German Patent Application DE 10 2005 033 186.6 filed Jul. 13, 2005, the entire contents of which are incorporated herein by reference.

### FIELD OF THE INVENTION

The present invention pertains to a process for manufacturing plastic moldings while increasing the coefficient of viscosity of the raw material used to manufacture it. It pertains, in particular, to the manufacture of such parts in an injection molding process. The present invention pertains, furthermore, to a molding manufactured according to the process.

### BACKGROUND OF THE INVENTION

Mechanical parts and elements, which previously consisted of metal, have been increasingly manufactured from plastics for the past several years. One advantage, which is of particular significance, for example, above all in the manufacture of automobiles, is the weight reduction resulting from the use of plastics. In addition, it is also possible to manufacture parts with complicated geometries from plastics in a comparatively simple manner due to the use of injection molding processes.

To make it possible to use the injection molding technique, the plastic must not, however, have an excessively high viscosity because only machining would be possible. On the other hand, it has been found that there is a directly proportional relationship between the loadability and hence also the service life of moldings manufactured from plastics and the coefficient of viscosity of the material. The slope of the proportionality line is so steep that a change in the coefficient of viscosity by only 15 points reduces the service life of, e.g., a toothed ring manufactured from plastic by half or doubles it. It is therefore important to select materials for the injection molding process that have a viscosity that is not too high in respect to their processing, on the one hand, but still have a coefficient of viscosity that ensures high loadability and long service life after the conclusion of the injection molding process, on the other hand.

Materials, preferably polyamides, which have an absolute viscosity or solution viscosity of 180 mL/g to 190 mL/g as delivered, are used now, in general, to manufacture plastic moldings, such as toothed rings and the like. However, the coefficient of viscosity decreases in the course of the injection molding process, doing so by up to 5 points. The loadability or service life of a molding manufactured from a plastic by injection molding decreases correspondingly. The chemical industry delivering the material is, of course, also able to deliver materials of higher viscosity, i.e., plastics with a higher coefficient of viscosity. However, the production of corresponding materials preferably takes place under altered extrusion conditions and leads, in general, to an increase in the cost of the raw material for injection molding.

### SUMMARY OF THE INVENTION

The object of the present invention is therefore to propose a process that can be used by the manufacturers of moldings manufactured by injection molding and by which moldings that have a high loadability based on the coefficient of viscosity of the material after the conclusion of the shaping process can be manufactured without an appreciable increase in the expense of the manufacturing process. Furthermore, a corresponding molding manufactured according to the process shall be made available.

According to the invention, a process is provided for manufacturing moldings from plastics. The process comprises processing a raw material that is in the form of a granular material in an injection molding process. During the processing the granular material is tempered over a period of time of 10 hours to 30 hours at a temperature between 90° C. and 150° C.

The granular material may advantageously be a granulated polyamide. In this case the polyamide may be tempered at a temperature between 110° C. and 130° C. for 10 hours to 12 hours. The tempering may advantageously be carried out over a period of 10 hours to 12 hours after reaching a temperature of 110° C. of the granular material.

According to another aspect of the invention, a plastic molding is provided. The plastic molding comprises a plastic molding part formed by processing a raw material that is in the form of a granular material in an injection molding process. During the processing, the granular material is tempered over a period of time of 10 hours to 30 hours at a temperature between 90° C. and 150° C. The material of the molding has a solution viscosity with a coefficient of viscosity between 180 mL/g and 200 mL/g after shaping.

The solution viscosity may advantageously be equal to or greater than an original solution viscosity of the granular material used to produce said solution viscosity with a coefficient of viscosity between 180 mL/g and 200 mL/g after shaping.

The molding forms a dynamically loaded part comprising one of a sliding element, bearing element, a gear part or a shaft part. The molding may be a worm gear or a spiral-toothed gear wheel. The molding may be a worm gear or a spiral-toothed gear wheel for use in the transmission of a power steering.

The granular material may be a granulated polyamide. The polyamide may be tempered at a temperature between 110° C. and 130° C. for 10 hours to 12 hours. The tempering may be carried out over a period of 10 hours to 12 hours after reaching a temperature of 110° C. of the granular material.

The various features of novelty which characterize the invention are pointed out with particularity in the claims annexed to and forming a part of this disclosure. For a better understanding of the invention, its operating advantages and specific objects attained by its uses, reference is made to the accompanying descriptive matter in which preferred embodiments of the invention are discussed.

### DESCRIPTION OF THE INVENTION

According to the process being proposed, plastic moldings are manufactured by processing a raw material that is in the form of a granular material in an injection molding process. However, the granular material is heated by the manufacturer of the moldings before the shaping (molding formation) processing in the injection molding process and tempered over a period of 10 hours to 30 hours at a temperature between 90° C. and 150° C. Granulated polyamide is preferably used to carry out the process.

The coefficient of viscosity of polyamide can be increased by heating or tempering the granular material used as the raw material for the injection molding process corresponding to a fixed temperature-time profile. The increase in the coefficient of viscosity obviously results now from the fact that molecules are crosslinked with one another based on a polycondensation reaction taking place due to the heat, so that longer chains are formed. However, the intermolecular forces become stronger in longer chains, so that the loadability of the material increases as a result in the form of the modulus of elasticity and especially the fatigue strength under reversed bending stresses.

The described type of pretreatment of the granular material is substantially more efficient than a thermal aftertreatment of the finished part. The benefit of the present invention is consequently that parts with higher loadability can be manufactured by the manufacturer of the plastic moldings from the same raw material corresponding to the customer's requirements. At the same time, a new field of use opens up for this material for applications for which high-priced materials are currently used. Thus, the manufacturer of the moldings has the potential to reduce costs.

Corresponding to a practical possibility of implementing the process according to the present invention for manufacturing plastic moldings from polyamide, it was possible to show in experiments that good results are obtained by tempering the material at a temperature between 110° C. and 130° C. over a period of 10 hours to 12 hours. It was possible to compensate or even overcompensate the reduction of the coefficient of viscosity occurring as a result of the injection molding in respect to the coefficient of viscosity of the material as delivered, on the one hand, and the coefficient of viscosity of the finished molding, on the other hand.

Especially good results were obtained for polyamide. For example, polyamide known under the trade name Ultramid A4H®, was used as the material that was tempered over a period of 10 hours to 12 hours after reaching a granule temperature of 110° C. before the injection molding. The tempered material was then used in an injection molding process.

A plastic molding manufactured according to the process according to the present invention has a solution viscosity with a coefficient of viscosity between 180 mL/g and 200 mL/g after shaping. It is characterized especially by the fact that its solution viscosity is equal to or greater than the original solution viscosity of the granular material used to manufacture it.

Rotating and dynamically loaded parts, such as sliding elements, gears or shafts, can be manufactured with a coefficient of viscosity between 180 mL/g and 200 mL/g according to the process according to the present invention, and corresponding coefficients of viscosity can be reached with raw materials that have a coefficient of viscosity between 180 mL/g and 190 mL/g as delivered. The reduction in the coefficient of viscosity occurring during injection molding is consequently at least compensated or, as it clearly appears from the above description, possibly even overcompensated. Worm gears or spiral-toothed gear wheels for use in the transmission of a power steering, which have a coefficient of viscosity between 180 mL/g and 200 mL/g after the conclusion of the shaping process despite the use of a rather low-priced polyamide with the above-mentioned coefficient of viscosity of 180 mL/g and 190 mL/g, can be preferably manufactured with the use of the process according to the present invention.

According to an exemplary application, corresponding worm gears or spiral-toothed gear wheels provided for use in EPS applications (power steering systems) are manufactured from Ultramid A4H® by heating the raw material to 110° C. and then tempering it for 12 hours. The worm gears are then manufactured in an injection molding process in the usual manner from the granular material pretreated according to the present invention. It is seen that without resorting to higher-priced materials, which inherently have a higher coefficient of viscosity than those purchased by the manufacturers of such moldings, in general for the purpose of injection molding, worm gears or spiral-toothed worm gears which have coefficients of viscosity between 180 mL/g and 200 mL/g, can be manufactured for the purpose. Corresponding worm gears and spiral-toothed gear wheels have a high loadability and service life, as a result of which they are suitable for use in EPS applications, obviously because of this comparatively high coefficient of viscosity.

While specific embodiments of the invention have been shown and described in detail to illustrate the application of the principles of the invention, it will be understood that the invention may be embodied otherwise without departing from such principles.

1-9. (canceled)

10. A process for manufacturing moldings from plastics, the process comprising:
processing a raw material that is in the form of a granular material in an injection molding process; and
during the processing, tempering the granular material over a period of time of 10 hours to 30 hours at a temperature between 90° C. and 150° C.

11. A process in accordance with claim 10, wherein the granular material is a granulated polyamide.

12. A process in accordance with claim 11, wherein the polyamide is tempered at a temperature between 110° C. and 130° C. for 10 hours to 12 hours.

13. A process in accordance with claim 12, wherein the tempering is carried out over a period of 10 hours to 12 hours after reaching a temperature of 110° C. of the granular material.

14. A plastic molding comprising:
a plastic molding part formed by processing a raw material that is in the form of a granular material in an injection molding process; and
during the processing, tempering the granular material over a period of time of 10 hours to 30 hours at a temperature between 90° C. and 150° C., wherein the material of the molding has a solution viscosity with a coefficient of viscosity between 180 mL/g and 200 mL/g after shaping the tempered granular material via the injection molding process to form said plastic molding part.

15. A plastic molding in accordance with claim 14, wherein said solution viscosity is equal to or greater than an original solution viscosity of the granular material used to produce said solution viscosity with a coefficient of viscosity between 180 mL/g and 200 mL/g after shaping the tempered granular material to form said plastic molding part via the injection molding process.

16. A plastic molding in accordance with claim 14, wherein the molding forms a dynamically loaded part comprising one of a sliding element, bearing element, a gear part or a shaft part.

17. A plastic molding in accordance with claim 14, wherein the molding is a worm gear or a spiral-toothed gear wheel.

18. A plastic molding in accordance with claim 17, wherein the molding is a worm gear or a spiral-toothed gear wheel for use in the transmission of a power steering.

19. A plastic molding in accordance with claim 14, wherein the granular material is a granulated polyamide.

20. A plastic molding in accordance with claim 19, wherein the polyamide is tempered at a temperature between 110° C. and 130° C. for 10 hours to 12 hours.

21. A plastic molding in accordance with claim 20, wherein the tempering is carried out over a period of 10 hours to 12 hours after reaching a temperature of 110° C. of the granular material.

22. A process for manufacturing moldings from plastics, the process comprising:
providing raw granular plastic material;
processing the granular material in an injection molding process; and
during the processing, tempering the granular material over a period of time of 10 hours to 30 hours at a temperature between 90° C. and 150° C. before shaping the granular material via said injection molding process.

23. A process in accordance with claim 22, wherein the granular material is a granulated polyamide.

24. A process in accordance with claim 23, wherein the polyamide is tempered at a temperature between 110° C. and 130° C. for 10 hours to 12 hours.

25. A process in accordance with claim 24, wherein the tempering is carried out over a period of 10 hours to 12 hours after reaching a temperature of 110° C. of the granular material.
